(19) United States
(12) Patent Application Publication
(10) Pub. No.: US 2026/0188806 A1
(43) Pub. Date: Jul. 2, 2026

(54) SECONDARY BATTERY, METHOD OF MANUFACTURING THE SECONDARY BATTERY AND ELECTRONIC DEVICE INCLUDING THE SECONDARY BATTERY

(71) Applicant: SAMSUNG SDI CO., LTD., Yongin-si (KR)

(72) Inventor: Junho BYEON, Yongin-si (KR)

(21) Appl. No.: 19/347,874

(22) Filed: Oct. 2, 2025

(30) Foreign Application Priority Data
Jan. 2, 2025 (KR) 10-2025-0000178

(51) Int. Cl. H01M 50/184; H01M 10/04; H01M 10/42; H01M 50/103; H01M 50/119; H01M 50/55

(52) U.S. Cl. CPC H01M 50/184; H01M 10/049; H01M 10/425; H01M 50/103; H01M 50/119; H01M 50/55

(57) ABSTRACT

A secondary battery includes an electrode assembly in which a first electrode, a separator, and a second electrode are stacked. A first case accommodates a first portion of the electrode assembly, and a second case accommodates a second portion of the electrode assembly. A center structure is disposed between the first case and the second case and surrounding one or more side surfaces of the electrode assembly, with the center structure being coupled to each of the first case and the second case. The center structure may include a plurality of coupling portions formed at one or more edges of the center structure.

### CROSS-REFERENCE TO RELATED APPLICATION

This application claims priority under 35 U.S.C. § 119 to Korean Patent Application No. 10-2025-0000178, filed in the Korean Intellectual Property Office on Jan. 2, 2025, the entire contents of which are hereby incorporated by reference.

### BACKGROUND

### Field

The present disclosure relates to a secondary battery, a method of manufacturing the secondary battery, and an electronic device including the secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Secondary batteries are used in various environments because of their excellent electrical properties. However, to increase energy density, the conventional pouch-type battery's outer casing is made as a thin film, making it susceptible to easy deformation and fracture upon physical impact. To overcome such limitations, batteries with stainless steel cases (referred to as “SUS can”) can be employed.

The SUS-can-type battery may be manufactured by aligning a can that accommodates an electrode assembly with a cover that closes an opening of the can, welding the four sides, and then cutting a flange portion. The flange remaining after the welding and cutting processes increases the volume of the secondary battery, thereby limiting volumetric utilization. Also, damage or defects may occur because the electrode assembly is heated while the stainless-steel case is being welded. Further, to provide a structure that allows easy attachment and detachment of the secondary battery to and from a housing, the above-described cutting process is inevitably required.

The above information disclosed in this Background section is for enhancement of understanding of the background of the present disclosure, and therefore, it may contain information that does not constitute related (or prior) art.

### SUMMARY

An aspect of the present disclosure is to provide a secondary battery including a center structure that resolves the above-described problems, a method of manufacturing the secondary battery, and an electronic device including the secondary battery.

These and other aspects and features of the present disclosure will be described in or will be apparent from the following description of embodiments of the present disclosure.

In some embodiments, a secondary battery includes an electrode assembly in which a first electrode, a separator, and a second electrode are stacked, a first case that accommodates a first portion of the electrode assembly, a second case that accommodates a second portion of the electrode assembly, and a center structure disposed between the first case and the second case and surrounding a side surface of the electrode assembly, the center structure being coupled to each of the first case and the second case, wherein the center structure includes a plurality of coupling portions formed at one or more edges of the center structure.

In some embodiments, the center structure comprises a rectangular-frame shape surrounding the one or more side surfaces of the electrode assembly, and the plurality of coupling portions may include a plurality of fastening portions positioned at one or more edges of the rectangular-frame shape and a plurality of fixing members coupled to the plurality of fastening portions.

In some embodiments, each of the fastening portions may be formed adjacent to a corner portion of the center structure.

In some embodiments, each of the fastening portions may be formed inside a corner portion of the center structure.

In some embodiments, each of the fastening portions may be formed outside a side portion of the center structure.

In some embodiments, a thickness of the fastening portions in a direction perpendicular to a plane of the rectangular-frame shape may be less than a thickness of the center structure in the direction perpendicular to the plane of the rectangular-frame shape.

In some embodiments, a first surface of the center structure may include a first groove to which the first case is coupled, and a second surface, which is opposite to the first surface, of the center structure may include a second groove to which the second case is coupled.

In some embodiments, the first groove may be configured to engage an end of an opening in the first case into which a portion of the electrode assembly is inserted, and the second groove may be configured to engage an end of an opening in the second case into which another portion of the electrode assembly is inserted.

In some embodiments, an adhesive material may be provided in each of the first groove and the second groove, and the first case and the second case may be fixedly coupled by the adhesive.

In some embodiments, the center structure may include a terminal portion through which a first terminal is electrically connected to the first electrode and a second terminal is electrically connected to the second electrode pass.

In some embodiments, the secondary battery may further include an insulator surrounding at least a portion of the first terminal and at least a portion of the second terminal that are disposed inside the center structure.

In some embodiments, the center structure may include an insulating material.

In some embodiments, each of the first case and the second case may include SUS.

In some embodiments, a method of manufacturing a secondary battery includes disposing an electrode assembly inside a center structure, the electrode assembly including a first electrode, a separator, and a second electrode are sequentially stacked, inside a center structure, coupling a first surface of the center structure to a first case from a first direction such that the first case accommodates a first portion of the electrode assembly, and coupling a second surface of the center structure, which opposite the first surface, to a second case from a second direction opposite the first direction such that the second case accommodates a second portion of the electrode assembly, wherein the center structure is disposed between the first case and the second case so as to surround one or more side surfaces of the electrode assembly and includes a plurality of coupling portions formed at one or more edges of the center structure.

In some embodiments, the plurality of coupling portions may include a plurality of fastening portions positioned at one or more edges of the center structure and a plurality of fixing members coupled to the plurality of fastening portions, and the method may further include coupling the plurality of fastening portions of the center structure to a support substrate of an electronic device by using the plurality of fixing members.

In some embodiments, the first surface of the center structure may include a first groove to which the first case is coupled, and the second surface of the center structure may include a second groove to which the second case is coupled, wherein coupling the first surface and the first case may include inserting the first case into the first groove to fixedly coupled the first surface and the first case, and coupling the second surface and the second case may include inserting the second case into the second groove to fixedly coupled the second surface and the second case.

In some embodiments, coupling the first surface and the first case may further include applying an adhesive material to the first groove, and coupling the second surface and the second case may further include applying an adhesive material to the second groove.

In some embodiments, an electronic device includes an operation unit configured to perform a preset operation, a housing that accommodates the operation unit such that the operation unit is fixed therein, and a secondary battery fixed to a support substrate inside the housing and configured to supply power to the operation unit, wherein the secondary battery includes an electrode assembly in which a first electrode, a separator, and a second electrode are stacked, a first case that accommodates a first portion of the electrode assembly, a second case that accommodates a second portion of the electrode assembly, and a center structure disposed between the first case and the second case and surrounding one or more side surfaces of the electrode assembly, the center structure being coupled to each of the first case and the second case, wherein the center structure includes a plurality of coupling portions formed at one or more edges of the center structure and fastened to the support substrate.

In some embodiments, the center structure may have a rectangular-frame shape configured surrounding the one or more side surfaces of the electrode assembly, and the plurality of coupling portions may include a plurality of fastening portions positioned at one or more edges of the rectangular-frame shape and a plurality of fixing members coupled to the plurality of fastening portions.

In some embodiments, the plurality of fastening portions may be detachably coupled to the support substrate by the plurality of fixing members.

According to some embodiments of the present disclosure, by providing a secondary battery where the flange portion, which remains after the welding and cutting processes of the case body and cover in conventional secondary batteries, is omitted, the unused area in the structure can be minimized, thereby providing the internal space of the secondary battery that accommodates the electrode assembly while maximizing the overall energy density of the secondary battery.

According to some embodiments of the present disclosure, a coupling portion is formed in the center structure included in the case of the secondary battery so that the secondary battery can be fixed to an electronic device. In a conventional pouch-type or SUS-can-type battery, it is difficult for a user to directly replace the battery. But with embodiments of the present disclosure, the center structure can be easily attached to and detached from the electronic device through a screw-shaped coupling portion formed in the center structure.

According to some embodiments of the present disclosure, by omitting welding and cutting processes for inter-coupling SUS cases in a method of manufacturing the secondary battery, damage or defects to the case or the electrode assembly during manufacture of the secondary battery can be minimized.

According to some embodiments of the present disclosure, a secondary battery that has a rigid outer case with maximized volumetric utilization of the secondary battery can be provided.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded view of a secondary battery according to an embodiment of the present disclosure.

FIG. 2 is a schematic perspective view of a secondary battery completed according to an embodiment of the present disclosure.

FIG. 3 illustrates engagement between the secondary battery of FIG. 2 and a housing according to an embodiment of the present disclosure.

FIG. 4 is a plan sectional view of the secondary battery of FIG. 2 taken along line A-A according to an embodiment of the present disclosure.

FIG. 5 is a plan sectional view of the secondary battery of FIG. 2 taken along line B-B according to an embodiment of the present disclosure.

FIG. 6 is a view of positions at which a plurality of fastening portions are formed according to an embodiment of the present disclosure.

FIG. 7 is a view of positions at which a plurality of fastening portions are formed according to an embodiment of the present invention.

FIG. 8 is a view of positions at which a plurality of fastening portions are formed according to an embodiment of the present disclosure.

FIG. 9 is a view of a thickness of a plurality of fastening portions according to an embodiment of the present disclosure.

FIG. 10 is a view of positions at which a plurality of fastening portions are formed according to one embodiment of the present disclosure.

FIG. 11 is a flowchart of a method of manufacturing a secondary battery according to an embodiment of the present disclosure.

FIG. 12 is a view of an electronic device in which a secondary battery according to an embodiment of the present disclosure is mounted.

FIG. 13 is a view of an electronic device according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

Also, it will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, in the figures, dimensions of the various elements, layers, etc. may be exaggerated for clarity of illustration. The same reference numerals designate the same elements.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, etc. may be used herein to describe various elements, these elements should not be limited by these terms. These terms are only used to distinguish one element from another element. Thus, a first element could be termed a second element unless the context clearly indicates otherwise.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components. It will also be understood that when an element is referred to as being “electrically coupled” to another element, it may be directly coupled to the other element or intervening elements may be present.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

In the present disclosure, the sizes and relative sizes of regions shown in the drawings may be exaggerated for clarity of illustration. That is, the sizes shown in the drawings are for ease of understanding only and are not limited thereto. In addition, the same reference numerals throughout the specification refer to the same components.

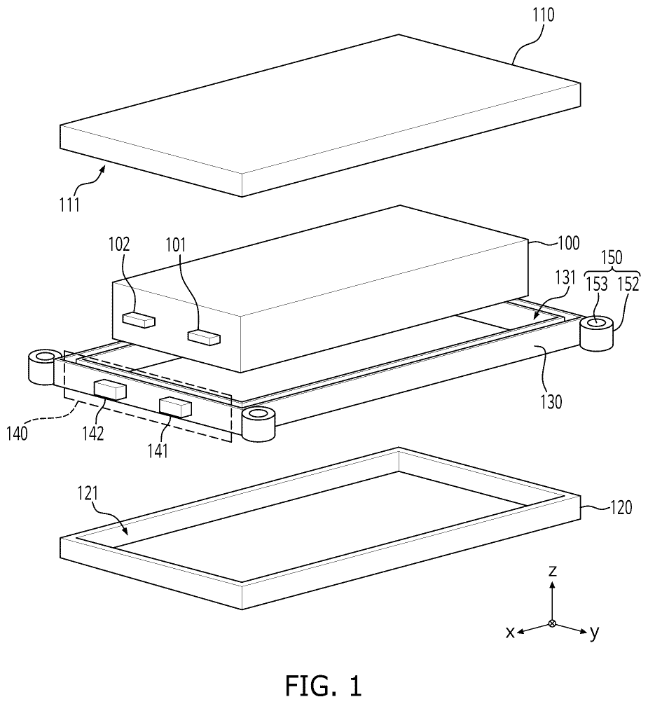

FIG. 1 is an exploded view of a secondary battery according to an embodiment of the present disclosure.

Referring to FIG. 1, a secondary battery according to an embodiment of the present disclosure may include an electrode assembly 100 in which a first electrode, a separator, and a second electrode are sequentially stacked. The secondary battery also includes a first case 110 that accommodates a portion of the electrode assembly 100. A second case 120 accommodates another portion of the electrode assembly 100. And a center structure 130 is disposed between the first case 110 and the second case 120.

In a state in which the first case 110, the second case 120, and the center structure 130 are tightly coupled, the first electrode, the separator, and the second electrode that constitute the electrode assembly 100 may be impregnated with an electrolyte (not shown). The first electrode may be a positive electrode or a negative electrode of the secondary battery, and the second electrode may have a polarity opposite to that of the first electrode. For example, when the first electrode is the positive electrode, the second electrode may be the negative electrode, and vice versa.

The first electrode may form the positive electrode by coating a positive-electrode active material on an aluminum (Al) substrate. The second electrode may form the negative electrode by coating a negative-electrode active material on a copper (Cu) substrate. Each of the first electrode and the second electrode may include a coated portion where an active material is applied on each side of a thin metal-plate substrate and an uncoated portion where the substrate is exposed and the active material is not provided.

A first electrode tab 101 is located on a side surface of the electrode assembly 100 may be formed as part of the uncoated portion of the first electrode. A second electrode tab 102 is also located on a side surface of the electrode assembly 100 as part of the uncoated portion of the second electrode.

As illustrated in FIG. 1 the first electrode tab 101 and the second electrode tab 102 may be formed on at least one surface of the electrode assembly 100. However, positions of the first electrode tab 101 and the second electrode tab 102 are not limited to those illustrated in FIG. 1 and may be changed as needed. For example, the first electrode tab 101 and the second electrode tab 102 may be provided on opposite sides of the electrode assembly 100.

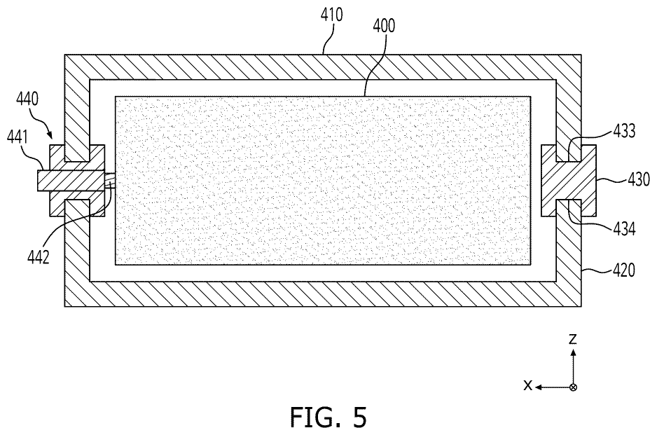

The secondary battery may further include a first terminal 141 and a second terminal 142. As illustrated in FIG. 1, the first terminal 141 and the second terminal 142 may be provided on at least one surface (e.g., a terminal portion 140) of the center structure 130. But the positions of the first terminal 141 and the second terminal 142 are not limited to those illustrated in FIG. 1 and may be changed in correspondence with positions of the first electrode tab 101 and the second electrode tab 102 as needed. For example, the first terminal 141 and the second terminal 142 may be provided on opposite sides of the center structure 130. Here, the first terminal 141 and the second terminal 142 may penetrate the terminal portion 140 of the center structure 130. The first terminal 141 and the second terminal 142 are coupled to the center structure 130 through the terminal portion 140, which will be described below with reference to FIG. 5.

The center structure 130 may be configured to surround the side surfaces of the electrode assembly 100 and may be tightly coupled to each of the first case 110 and the second case 120.

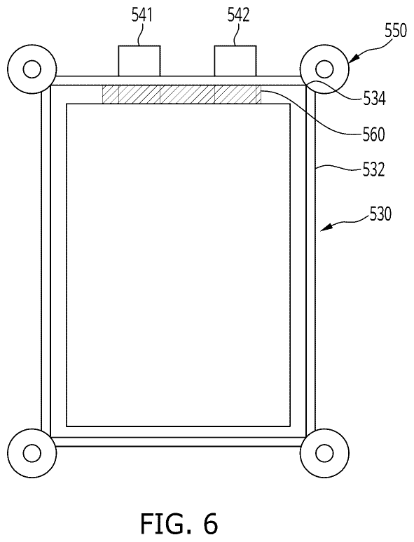

The center structure 130 may include a plurality of coupling portions 150 formed at an edge of the center structure 130. In one embodiment, the center structure 130 may have a rectangular-frame shape that surrounds the side surfaces of the electrode assembly 100. In this configuration, each of the coupling portions 150 may be formed at a corner portion of the rectangular-frame shape. However, the present disclosure is not limited thereto, and various embodiments of the coupling portions 150 will be described later with reference to FIGS. 6 to 8.

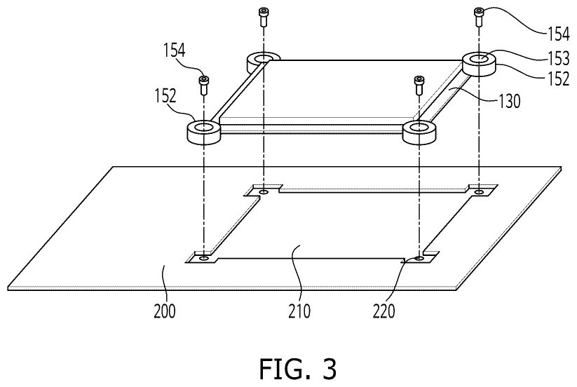

The plurality of coupling portions 150 may include a plurality of fastening portions 152 formed at an edge of the rectangular-frame shape and a plurality of fixing members 154 (see FIG. 3) coupled to the plurality of fastening portions 152. Each of the fastening portions 152 may have a cylindrical shape or a rectangular-column shape, but the present disclosure is not limited thereto. A through-hole 153 may be formed in a circular shape in the center of each of the fastening portions 152. The fixing members may be respectively fastened to the through-holes 153 of the fastening portions 152. The secondary battery may be attached to and detached from an electronic device by the plurality of fastening portions 152 and the plurality of fixing members 154. Such an arrangement will be described later with reference to FIG. 3.

A current collector (not shown) may be interposed between the electrode assembly 100 and the center structure 130. The current collector may form a path through which electrons move during charging and discharging of the secondary battery while being electrically connected to the first electrode or the second electrode. The current collector may be, for example, aluminum foil, copper foil, nickel foil, stainless-steel foil, titanium foil, nickel foam, copper foam, a polymer substrate coated with a conductive metal, and combinations thereof.

Although not illustrated, the first electrode tab 101 may be connected to the first terminal 141 through a first current collector (not shown) electrically connected to the first electrode. The second electrode tab 102 may be connected to the second terminal 142 through a second current collector (not shown) electrically connected to the second electrode. With this configuration, the first electrode of the electrode assembly 100 may be connected to the first terminal 141, and the second electrode of the electrode assembly 100 may be connected to the second terminal 142.

The center structure 130 may include an internal cavity 131 that accommodates a portion of the electrode assembly 100. Specifically, the internal cavity 131 be an open space inside the center structure 130 that corresponds to a shape of the electrode assembly 100. For example, in the embodiment depicted in FIG. 1, when the electrode assembly 100 has a rectangular or hexagonal column (rectangular or hexagonal prism shape) formed by stacking rectangular plates, the center structure 130 may have a rectangular-ring shape, and the internal cavity 131 may have a rectangular-plane shape.

The first case 110 and the second case 120 form the outer appearance of the secondary battery and may be formed of a conductive metal or polymer, such as a metal including SUS (stainless use steel), an aluminum alloy, or nickel-plated steel. For example, to provide the secondary battery with a rigid outer case, the first case 110 and the second case 120 may be formed of a metal including SUS.

The first case 110 and the second case 120 may provide the space in which the electrode assembly 100 is housed. In addition, like the center structure 130, the first case 110 and the second case 120 may be made in a shape corresponding to a shape of the electrode assembly 100 so as to house the electrode assembly 100. For example, as illustrated in FIG. 1, when the electrode assembly 100 is a rectangular-column or prismatic shape in which rectangular plates are stacked, the first case 110 and the second case 120 may have a rectangular-can shape having an opening formed on a wide surface.

After the electrode assembly 100 is disposed so that a portion of the electrode assembly 100 is accommodated in the internal cavity 131 of the center structure 130, the first case 110 and the second case 120 may be coupled to the center structure 130 to seal the internal cavity 131. The structure of the center structure 130 in this regard will be described below with reference to FIG. 3.

According to an embodiment, an opening 111 may be formed in a surface of the first case 110. The first case 110 may accommodate a portion of the electrode assembly 100 through the opening 111 of the first case 110. Similarly, an opening 121 may be formed in a surface of the second case 120, and the second case 120 may accommodate a portion of the electrode assembly 100 through the opening 121 of the second case 120. For this purpose, the opening 111 of the first case 110 and the opening 121 of the second case 120 may be made in a shape corresponding to a shape of the electrode assembly 100.

According to an embodiment, either the first case 110 or the second case 120 may include an electrolyte injection port (not shown). For example, the electrolyte injection port may be a through-hole formed in at least one surface of the first case 110 or the second case 120. The electrolyte injection port may be formed so that an electrolyte can be injected into the secondary battery after the internal cavity 131 is sealed by coupling the first case 110 or the second case 120 with the center structure 130. In another embodiment, the center structure 130 may include the electrolyte injection port. For example, the electrolyte injection port may be a through-hole formed in at least one surface of the center structure 130. The electrolyte injection port may be sealed with a sealing member after the electrolyte is injected.

An insulating coating material may be applied at a predetermined thickness to an outer circumferential surface or an inner circumferential surface of each of the first case 110 and the second case 120. Although the first case 110 and the second case 120 are illustrated in FIG. 1 as rectangular-shaped having sharp edges, the scope of the present disclosure is not limited thereto. Cases of various other shapes such as ones having rounded rectangles or ellipses are possible.

At least one turn of finishing tape may be attached to an outer surface of the electrode assembly 100. The electrode assembly 100 may be disposed inside the center structure 130 with the finishing tape attached such that the finishing tape is located between the electrode assembly 100 and the center structure 130 and/or between the electrode assembly 100 and the cases 110 and 120.

Here, the finishing tape may be formed of an insulating material having high durability to electrically insulate the electrode assembly 100 from the center structure 130 and/or the cases 110 and 120. For example, the finishing tape may be formed of an insulating polymer including polypropylene (PP), polyimide (PI), ethylene-propylene-diene rubber (EPDM), polyethylene terephthalate (PET), polycarbonate (PC), polytetrafluoroethylene (PTFE), or combinations thereof. However, the material of the finishing tape is not limited to the above-listed materials and may include various materials having excellent plasticity and insulating properties commonly used in the art as needed.

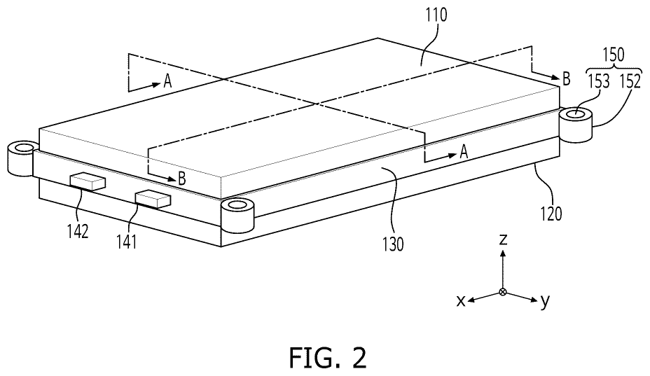

FIG. 2 is a schematic perspective view of a secondary battery completed according to an embodiment of the present disclosure.

Referring to FIG. 2, the electrode assembly of the secondary battery may be sealed such that a central portion of a side surface of the electrode assembly is accommodated inside the center structure 130. The upper and lower portions of the electrode assembly are respectively accommodated by the first case 110 and the second case 120 while being tightly coupled to each other.

The outer surface of the electrode assembly may be attached with the finishing tape so that the electrode assembly does not move upward, downward, forward, or backward in the internal cavity 131 of the center structure 130, in the interior of the first case 110, or in the interior of the second case 120. With this configuration, separation or damage of connection portions where configurations of the secondary battery such as the first terminal 141 or the second terminal 142 are connected with the electrode assembly can be prevented due to movement of the electrode assembly. And, even when the electrode assembly excessively expands due to charging and discharging, cracks in the center structure 130, the first case 110, the second case 120, or the electrode assembly itself can be suppressed because of the buffering.

By using a structure that accommodates the electrode assembly with the tight coupling of the cases 110, 120 and the center structure 130, a secondary battery can be provided that maximizes volumetric utilization while having a rigid exterior.

A secondary battery according to an embodiment of the present disclosure may include a lithium-ion battery cell, etc. However, the scope of the present disclosure is not limited with respect to the type of battery, and a battery cell or a secondary battery may be any type of battery that is capable of repeatedly supplying electricity through charging and discharging. A secondary battery according to an embodiment may be used in automobiles, cellular phones, and/or various types of electronic devices. But the present disclosure is not limited to these examples.

FIG. 3 is illustrates engagement between the secondary battery of FIG. 2 and a housing 200 of an electronic device according to an embodiment of the present disclosure.

As illustrated, a plurality of coupling portions may be formed outside an edge of the center structure 130 that is coupled to upper and lower cases of the secondary battery. The plurality of coupling portions may include a plurality of fastening portions 152 and a plurality of fixing members 154The plurality of fixing members 154 may include, for example, screws, and the plurality of fastening portions 152 may include, for example, screw taps to which the screws are fastened.

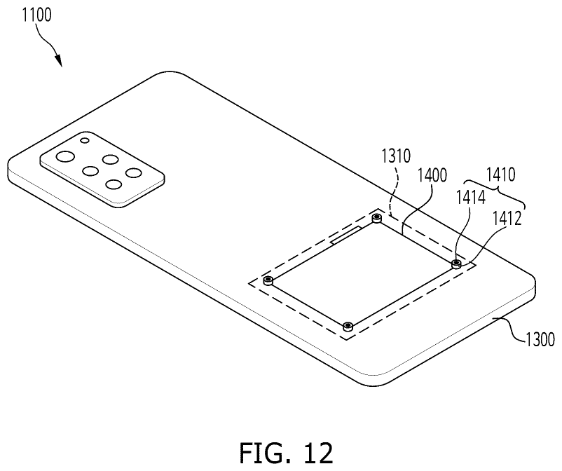

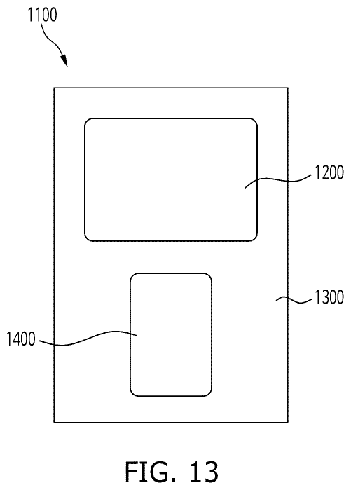

The plurality of coupling portions may be combined with electronic devices of various forms. The electronic device may include the housing 200, and the housing 200 may include a support substrate 210 to which the secondary battery is fixedly coupled. The configuration of the electronic device will be described below with reference to FIGS. 12 and 13.

A plurality of holes corresponding to the plurality of fastening portions 152 may be formed in the support substrate 210 of the housing. For example, each through-hole 153 formed in the fastening portions 152 may correspond to one of the holes 220 formed in the support substrate 210 of the housing 200. Each through-hole 153 formed in the center of each of the fastening portions 152 and each of the holes 220 formed in the support substrate 210 may be located on a straight line in the vertical direction of the support substrate 210. Subsequently, the fixing members 154 may be fastened in the vertical direction of the support substrate 210 through the holes 220 formed in the support substrate 210 and the corresponding fastening portions 152.

In a conventional pouch-type battery, it is difficult for a user to directly replace the battery. However, with a configuration as in the present disclosure, it is possible to easily attach and detach the battery from the electronic device through the screw-shaped coupling portions formed on the center structure 130.

Previously, to form a structure that enables easy attachment and detachment, the flange portion of a conventional battery case had to be cut into a screw shape. However, according to the various embodiments of the present disclosure, welding and cutting processes for coupling stainless-steel cases with each other are omitted in the method of manufacturing the secondary battery. Thus, the risk of damage and defects to the secondary battery can be minimized.

According to FIG. 3, a groove is formed in the housing 200 so that the housing 200 corresponds to a shape of the secondary battery having the center structure 130, and the support substrate 210 is formed therein. However, the present disclosure is not limited to the depicted configuration described above, and shapes of the support substrate 210 for mounting the secondary battery may vary.

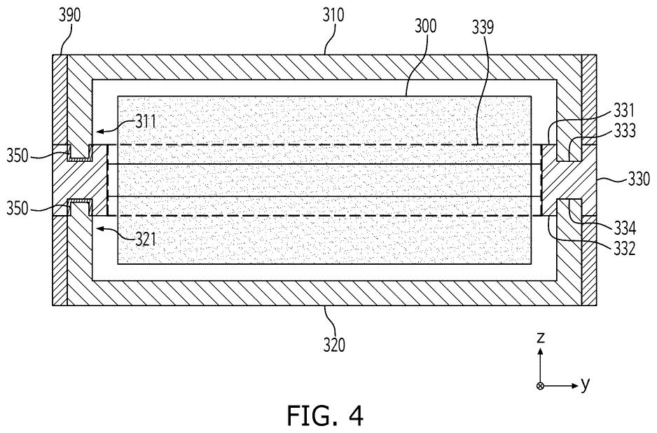

FIG. 4 is a sectional view of the secondary battery of FIG. 2 taken along line A-A according to an embodiment of the present disclosure.

Referring to FIG. 4, a first surface 331 of a center structure 330 may include a first groove 333 to which a first case 310 is coupled, and a second surface 332 opposite the first surface 331 of the center structure 330 may include a second groove 334 to which a second case 320 is coupled. The center structure 330 may also include an internal cavity 339 that accommodates a portion of an electrode assembly 300. The internal cavity 339 may be a space having the inner circumferential surface of the center structure 330.

Specifically, the first surface 331 or the second surface 332 of the center structure 330 may connect an outer circumferential surface and an inner circumferential surface of the center structure 330 having a closed-ring shape. For example, in the center structure 330 illustrated in FIG. 3, the first surface 331 may refer to a surface facing the first case 310, and the second surface 332 may refer to a surface facing the second case 320.

Here, the second surface 332 of the center structure 330 may face the first surface 331 of the center structure 330. Accordingly, the first groove 333 included in the first surface 331 and the second groove 334 included in the second surface 332 may also face each other. The first case 310 that is coupled to the first groove 333 and the second case 320 that is coupled to the second groove 334 may also face each other.

The first groove 333 may be configured to engage an end 311 of an opening of the first case 310 into which a portion of the electrode assembly 300 is inserted. The second groove 334 may be configured to engage an end 321 of an opening of the second case 320 into which another portion of the electrode assembly 300 is inserted. According to an embodiment, the first groove 333 located on the first surface 331 of the center structure 330 may correspond to the end 311 of the opening of the first case 310, and the second groove 334 located on the second surface 332 of the center structure 330 may correspond to the end 321 of the opening of the second case 320.

The first groove 333 may have a closed-ring shape recessed to a predetermined depth along a shape of the center structure 330. A width of the first groove 333 may correspond to a thickness of a metal plate constituting the end 311 of the opening of the first case 310. With this configuration, the end 311 of the opening of the first case 310 can be fitted into the first groove 333.

Like the first groove 333, the second groove 334 may have a closed-loop shape recessed to a predetermined depth following the shape of the center structure 330, and the width of the second groove 334 may correspond to the thickness of a metal plate constituting the end 321 of the opening of the second case 320. With this configuration, the end 321 of the opening of the second case 320 can be fitted into the second groove 334. While the shapes of the first groove 333 and the second groove 334 may differ, for a simple secondary battery manufacturing process, the shapes may be symmetric to each other.

An adhesive material 350 may be provided in each of the first groove 333 and the second groove 334. Because of the adhesiveness of the adhesive material 350, the first case 310 and the center structure 330 are fixedly coupled to each other, and the second case 320 and the center structure 330 are fixedly coupled to each other.

The adhesive material 350 may be a material having high bonding strength to couple the first case 310 and the center structure 330 and to couple the second case 320 and the center structure 330. For example, the adhesive material 350 may be epoxy resin, polyurethane adhesive, silicone adhesive, cyanoacrylate, polyvinyl acetate (PVA), polyimide adhesive, polyamide adhesive, UV-curable adhesive, or combinations thereof. However, the material of the adhesive material 350 is not limited to these examples and may include various other materials having excellent adhesiveness as needed.

In a conventional secondary battery having a rigid outer case such as SUS, because the cup-shaped body case accommodating the electrode assembly and the cover case are sealed through welding and cutting processes, the secondary battery includes a flange portion that must be cut in the battery manufacturing. But in a secondary battery according to the present disclosure, the electrode assembly 300 is sealed in the internal cavity 339 through fitting engagement, thereby minimizing an unused region 390. That is, according to some embodiments of the present disclosure, by providing a novel secondary battery structure without a flange portion remaining after welding and cutting processes, the unused region 390 can be minimized. Additionally, the configuration according to the present disclosure allows for the securing of the internal space of the secondary battery that accommodates the electrode assembly, and the overall energy density of the secondary battery can be maximized.

FIG. 5 is a plan sectional view of the secondary battery of FIG. 2 taken along line B-B.

Referring to FIG. 5, the center structure 430 may include a terminal portion 440 through which a first terminal 441 electrically connected to the first electrode and a second terminal electrically connected to the second electrode extend. In FIG. 5, only the first terminal 441 that extends through the terminal portion 440 of the center structure 430 is illustrated. However, the second terminal may also extend through the terminal portion 440 of the center structure 430. Here, the terminal portion 440 may refer to a side surface of the center structure 430.

The center structure 430 may be formed integrally except for the terminal portion 440, which may be made of the same material. In another embodiment, the center structure 430 may be formed integrally with the terminal portion 440. The terminal portion 440 may include a first groove 433, which is coupled to the first case 410, and a second groove 434, opposite to the first groove 433, that is coupled to the second case 420.

The first terminal 441 may extend through a space between the first groove 433 and the second groove 434. Likewise, the second terminal may extend through the space between the first groove 433 and the second groove 434. In such a configuration, the first terminal 441 and the second terminal may not be in contact with the first case 410 and the second case 420. A thickness of the first terminal 441 and the second terminal may be less than a minimum distance between the first case 410 and the second case 420.

The first terminal 441 may be connected to a first electrode tab 442 located on a side surface of the electrode assembly 400. Specifically, the first terminal 441 may be connected to the first electrode tab 442 that is a part of an uncoated portion of the first electrode of the electrode assembly 400. A first current collector may be interposed between the first terminal 441 and the first electrode tab 442.

The first electrode tab 442 and the first terminal 441 may be coupled through welding. For the welding, any one of ultrasonic welding, laser welding, resistance welding, TIG welding, or combinations thereof may be used. But the welding method is not limited to the types of welding and may be various other methods commonly used in the art to weld two materials as needed.

Although not illustrated, the second terminal may likewise extend through the terminal portion 440 of the center structure 430 like the first terminal 441. The second terminal may be connected to a second electrode tab that is a part of an uncoated portion of the second electrode of the electrode assembly 400, and a second current collector may be interposed between the second terminal and the second electrode tab. The method of coupling the second electrode tab and the second terminal may also be the same as the method of coupling the first electrode tab 442 and the first terminal 441.

The center structure 430 may include an insulating material. The center structure 430 may be formed of an insulating material having high insulating properties to electrically insulate between the first case 410 coupled to the first groove 433 and the second case 420 coupled to the second groove 434 of the center structure 430.

The terminal portion 440 of the center structure 430 may be formed of an insulator. Specifically, the terminal portion 440 may be formed of an insulating material having high insulating properties to electrically insulate between the first case 410 coupled to the first groove 433 of the center structure 430 and the first terminal 441 and to insulate between the second case 420 coupled to the second groove 434 of the center structure 430 and the first terminal 441.

In some examples, the center structure 430 and/or the terminal portion 440 may be formed of a polymer including ethylene-propylene-diene rubber (EPDM), polypropylene (PP), polyimide (PI), polyethylene terephthalate (PET), polycarbonate (PC), polytetrafluoroethylene (PTFE), or combinations thereof. In other examples, the center structure 430 and/or the terminal portion 440 may be formed of a ceramic material including parylene, alumina (Al₂O₃), zirconia (ZrO₂), aramid fiber, NOMEX®, epoxy resin, or combinations thereof. However, materials of the terminal portion 440 are not limited to these examples and may include various materials having excellent durability and insulating properties as needed.

The center structure 430 may be integrally formed with the terminal portion 440 so that the entire center structure 430 is formed of the same material as the above-described insulator. In another embodiment, the terminal portion 440 of the center structure 430 may be formed of a conductive metal.

An insulator configured to surround at least a portion of the first terminal 441 and the second terminal disposed inside the center structure 430 may be further included. A first insulating layer may be disposed between the first terminal 441 and the terminal portion of the center structure 430. And a second insulating layer may be disposed between the second terminal and the terminal portion of the center structure 430.

An adhesive material may be applied between the first terminal 441 and the first insulating layer or between the second terminal and the second insulating layer. The adhesive material may be, for example, epoxy resin, polyurethane adhesive, silicone adhesive, cyanoacrylate, polyvinyl acetate (PVA), polyimide adhesive, polyamide adhesive, UV-curable adhesive, or combinations thereof. However, the adhesive material is not limited to these examples and may include various materials having high bonding strength as needed.

The first insulating layer and the second insulating layer may be formed of an insulating material having high durability. For example, each of the first insulating layer, the second insulating layer, and a third insulating layer may be formed of an insulating polymer such as polypropylene (PP), polyimide (PI), ethylene propylene diene monomer rubber (EPDM), polyethylene terephthalate (PET), polycarbonate (PC), polytetrafluoroethylene (PTFE), or combinations thereof. However, materials of the first insulating layer and the second insulating layer are not limited to these examples and may be various materials having excellent plasticity and insulating properties commonly used in the art.

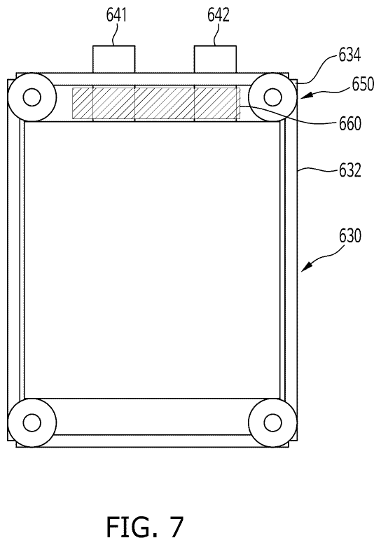

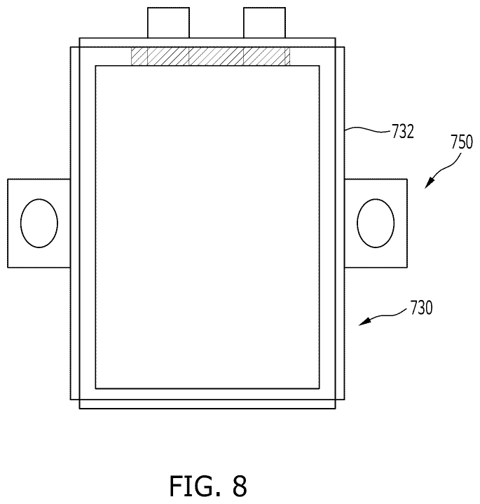

FIG. 6 is a view of positions at which a plurality of fastening portions 550 are formed according to an embodiment of the present disclosure. FIG. 7 is a view of positions at which a plurality of fastening portions 650 are formed according to an embodiment of the present disclosure. FIG. 8 is a view of positions at which a plurality of fastening portions 750 are formed according to an embodiment of the present disclosure.

Referring to FIG. 6, each of the plurality of fastening portions 550 may be formed outside a corner portion 534 of a center structure 530. The center structure 530 may include an outer surface 532 protruding between the first case and the second case in a completed state. The outer surface 532 of the center structure 530 may have a rectangular-frame shape having an internal cavity, and a plurality of fastening portions 550 may be respectively formed at each corner portion 534 of the rectangular-frame shape. The fastening portions 550 may be spaced apart from the first terminal 541 and the second terminal 542.

Referring to FIG. 7, in another embodiment each of the plurality of fastening portions 650 may be formed inside a corner portion 634 of a center structure 630. The center structure 630 may include an inner surface opposite to an outer surface 632 of the center structure 630. The fastening portions 650 may be respectively formed at each corner portion 534 of the inner surface of the center structure 630. The fastening portions 650 may be spaced apart from the first terminal 641, the second terminal 642, and an insulator 660 that surrounds the first terminal 641 and the second terminal 642. Each of the fastening portions 650 formed at the corner portions 634 may be spaced apart from the internal electrode assembly. When the plurality of fastening portions 650 are formed on the inner surface of the center structure 630, shapes of the first case and the second case may vary. When the first case and the second case are coupled to the center structure 630, the plurality of fastening portions 650 may be exposed upward and downward in a direction perpendicular to a plane of the rectangular-frame shape.

Referring to FIG. 8, in another embodiment each of the plurality of fastening portions 750 may be formed on the outside of a side portion of a center structure 730. The fastening portions 750 may be formed on outer surfaces 732 except for the surface of the center structure on which a terminal portion is formed. For example, the fastening portions 750 may be formed on two outer surfaces 732 adjacent to the surface on which a terminal portion is formed. In FIG. 8, two fastening portions are formed on the outer surface 732, but the present disclosure is not limited thereto. The fastening portions 750 may be located at the center of the outer surface 732 on which the plurality of fastening portions 750 are formed and the positions of the fastening portions 750 may vary according to a coupling method with an electronic device.

In each of the embodiments described in FIGS. 6 to 8, insulators 560 and 660 may be formed between the electrode assembly and the center assemblies 530, 630, 730, as described above with reference to FIG. 5.

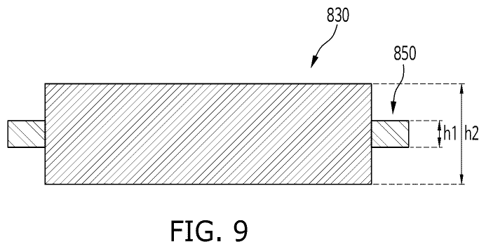

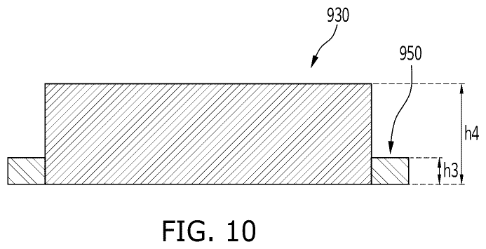

FIG. 9 is a view illustrating a thickness of fastening portions according to an embodiment of the present disclosure. FIG. 10 is a view illustrating positions at which the fastening portions are formed according to an embodiment of the present disclosure.

Referring to FIG. 9, a thickness h₁ of the fastening portions 850 may be less than a thickness h₂ of a center structure 830. For example, when the center structure 830 has a rectangular-frame shape, a thickness h₁ of the fastening portions 850 in a direction perpendicular to a plane of the rectangular-frame shape may be less than a thickness h₂ of the center structure 830 in the direction perpendicular to the plane of the rectangular-frame shape. However, the present disclosure is not limited to such a configuration, and the thickness h₁ of the fastening portions 850 in the direction perpendicular to the plane of the rectangular-frame shape may be equal to the thickness h₂ of the center structure 830 in the direction perpendicular to the plane of the rectangular-frame shape.

Referring to FIG. 10, the fastening portions 950 may be formed at a portion other than the center of an outer surface of a center structure 930. For example, as depicted, the fastening portions 950 may be formed at a lower end portion of the outer surface of the center structure 930.

According to an embodiment, an upper surface and a lower surface of the plurality of fastening portions 950 may be perpendicular to a rectangular-frame shape of the center structure 930, and an upper surface and a lower surface of the center structure 930 may be perpendicular to the rectangular-frame shape of the center structure 930. For example, the lower surfaces of the plurality of fastening portions 950 and the lower surface of the center structure 930 may lie in the same plane.

A thickness h₃ of the plurality of fastening portions 950 and a thickness h₄ of the center structure 930 may correspond to distances from a lower surface to an upper surface of each of the plurality of fastening portions 950 and the center structure 930. The thickness h₃ of the fastening portions 950 may be less than the thickness h₄ of the center structure 930.

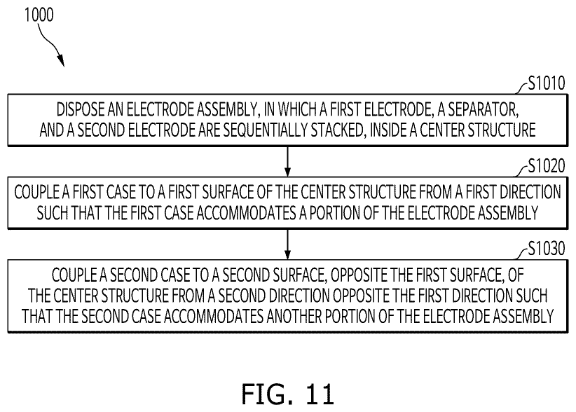

FIG. 11 is a flowchart of a method of manufacturing a secondary battery according to an embodiment of the present disclosure.

A method 1000 of manufacturing a secondary battery may start with disposing an electrode assembly, in which a first electrode, a separator, and a second electrode are sequentially stacked, inside a center structure (S1010).

Subsequently, a first case may be coupled to a first surface of the center structure from a first direction such that the first case accommodates a portion of the electrode assembly (S1020). Here, the first surface of the center structure may include a first groove to which the first case is coupled. That is, the first case may be inserted into the first groove to be fixedly coupled thereto.

Thereafter, a second case may be coupled to a second surface, opposite the first surface, of the center structure from a second direction that is opposite the first direction such that the second case accommodates another portion of the electrode assembly (S1030). Here, the second surface of the center structure may include a second groove to which the second case is coupled. For example, coupling the second surface and the second case may include inserting the second case into the second groove to be fixedly coupled thereto.

Coupling the first surface and the first case may include applying an adhesive material to the first groove. Likewise, coupling the second surface and the second case may include applying an adhesive material to the second groove. The adhesive material be the same as described with reference to FIG. 4.

The center structure may be disposed between the first case and the second case so as to surround side surfaces of the electrode assembly and may include a plurality of coupling portions formed at an edge of the center structure. The plurality of coupling portions may include a plurality of fastening portions formed at an edge of the center structure and a plurality of fixing members coupled to the plurality of fastening portions. By using the plurality of fixing members, the plurality of fastening portions of the center structure may be coupled to a support substrate of an electronic device.

The flowchart of FIG. 11 and the above description are merely an example of the present disclosure, and the scope of the present disclosure is not limited to the flowchart of FIG. 11 and the above description. For example, one or more steps of the flowchart and the above description may be added, changed, or deleted; an order of one or more steps may be changed; and one or more steps may be performed simultaneously.

FIG. 12 is a view of an electronic device in which a secondary battery according to an embodiment of the present disclosure is mounted. FIG. 13 is a view of an electronic device according to an embodiment of the present disclosure. A secondary battery according to an embodiment of the present disclosure may be used in automobiles, cellular phones, and/or various types of electronic devices. But the present disclosure is not limited to these examples.

Referring to FIGS. 12 and 13, a battery electronic device 1100 according to an embodiment of the present disclosure may include an operation unit 1200 configured to perform operation(s), a housing 1300 that accommodates the operation unit 1200 therein, and a secondary battery 1400 fixed inside the housing 1300 to supply power to the operation unit 1200. As one example, the battery electronic device 1100 including the power unit 1400 may be a smartphone. However, the device is not limited to a smartphone and may be used in various devices that use electrical energy stored in the power unit 1400, which is a secondary battery, and require a protection circuit.

The operation unit 1200 may include various hardware driven by electrical energy supplied from the secondary battery 1400. For example, the operation unit 1200 may include an application processor (AP) or a central processing unit (CPU) of a portable electronic device.

A printed circuit board (not shown) having signal-transmission wiring may be disposed inside the housing 1300. The operation unit 1200 may be mounted on the printed circuit board to be electrically connected with other components of the battery electronic device 1100.

The housing 1300 may accommodate the operation unit 1200 and the secondary battery 1400 therein and may define an outer appearance of the battery electronic device 1100. The housing 1300 may be provided as various structures as long as the housing 1300 supports the operation unit 1200 and the secondary battery 1400 disposed inside and the housing 1300 protects the components from external impact. According to an embodiment, the housing 1300 may include a support substrate 1310 therein to fix the secondary battery 1400.

The secondary battery 1400 may be fixed inside the housing 1300 to stably supply power to the operation unit 1200. The secondary battery 1400 may have substantially the same configuration as the secondary battery described above with reference to FIGS. 1 to 10.

The secondary battery 1400 may be disposed in the power region inside the housing 1300 and can be connected to the terminal of the printed circuit board. Accordingly, the operation unit 1200 can be driven using the electrical energy stored in the first battery cell and the second battery cell.

The secondary battery 1400 may include an electrode assembly in which a first electrode, a separator, and a second electrode are sequentially stacked; a first case that accommodates a portion of the electrode assembly; a second case that accommodates another portion of the electrode assembly; and a center structure disposed between the first case and the second case so as to surround a side surface of the electrode assembly and tightly coupled to each of the first case and the second case. These structures may be as described above.

The center structure may have a rectangular-frame shape configured to surround the side surfaces of the electrode assembly. And the center structure may include a plurality of coupling portions 1410 formed at an edge of the center structure and configured to be fastened to the support substrate.

The plurality of coupling portions 1410 may include a plurality of fastening portions 1412 formed at an edge of the rectangular-frame shape and a plurality of fixing members 1414 coupled to the plurality of fastening portions 1412. With this configuration, the plurality of fastening portions 1412 may be detachably coupled to the support substrate 1310 formed in the housing 1300 of the electronic device 1100 by the plurality of fixing members 1414.

According to an embodiment, the center structure of the secondary battery 1400 may include at least one screw tap to which a screw is fastened. The at least one screw tap may be mounted to the housing 1300 by screws.

Although the present disclosure has been described above with respect to embodiments thereof, the present disclosure is not limited thereto. Various modifications and variations can be made thereto by those skilled in the art within the spirit of the present disclosure.

### EXPLANATION OF REFERENCE SYMBOLS

100: electrode assembly
110: first case
120: second case
130: center structure
140: electrode-terminal portion
150: coupling portion

What is claimed is:

1. A secondary battery comprising:
an electrode assembly in which a first electrode, a separator, and a second electrode are stacked;
a first case that accommodates a first portion of the electrode assembly;
a second case that accommodates a second portion of the electrode assembly; and
a center structure disposed between the first case and the second case and surrounding one or more side surfaces of the electrode assembly, the center structure being coupled to each of the first case and the second case,
wherein the center structure comprises a plurality of coupling portions formed at one or more edges of the center structure.

2. The secondary battery as claimed in claim 1, wherein the center structure comprises a rectangular-frame shape surrounding the one or more side surfaces of the electrode assembly, and the plurality of coupling portions comprise a plurality of fastening portions positioned at the one or more edges of the rectangular-frame shape and a plurality of fixing members coupled to the plurality of fastening portions.

3. The secondary battery as claimed in claim 2, wherein each of the fastening portions is formed adjacent to a corner portion of the center structure.

4. The secondary battery as claimed in claim 2, wherein each of the fastening portions is formed inside a corner portion of the center structure.

5. The secondary battery as claimed in claim 2, wherein each of the fastening portions is formed outside a side portion of the center structure.

6. The secondary battery as claimed in claim 2, wherein a thickness of the fastening portions in a direction perpendicular to a plane of the rectangular-frame shape is less than a thickness of the center structure in the direction perpendicular to the plane of the rectangular-frame shape.

7. The secondary battery as claimed in claim 1, wherein the center structure comprises a first surface and a second surface opposite to the first surface,
wherein the first surface of the center structure comprises a first groove to which the first case is coupled, and
wherein the second surface of the center structure comprises a second groove to which the second case is coupled.

8. The secondary battery as claimed in claim 7, wherein the first groove is configured to engage an end of an opening into the first case into which the first portion of the electrode assembly is inserted, and
wherein the second groove is configured to engage an end of an opening in the second case into which the second portion of the electrode assembly is inserted.

9. The secondary battery as claimed in claim 7, wherein an adhesive material is provided in each of the first groove and the second groove, and
wherein the first case and the second case are fixedly coupled by the adhesive.

10. The secondary battery as claimed in claim 1, wherein the center structure comprises a terminal portion through which a first terminal is electrically connected to the first electrode and a second terminal is electrically connected to the second electrode pass.

11. The secondary battery as claimed in claim 10, further comprising an insulator surrounding at least a portion of the first terminal and at least a portion the second terminal that are disposed inside the center structure.

12. The secondary battery as claimed in claim 1, wherein the center structure comprises an insulating material.

13. The secondary battery as claimed in claim 1, wherein each of the first case and the second case comprises SUS.

14. A method of manufacturing a secondary battery, the method comprising:
disposing an electrode assembly inside a center structure, the electrode assembly comprising a stack of a first electrode, a separator, and a second electrode;
coupling a first surface of the center structure to a first case from a first direction such that the first case accommodates a first portion of the electrode assembly; and
coupling a second surface of the center structure, which is opposite to the first surface, to a second case from a second direction opposite the first direction such that the second case accommodates a second portion of the electrode assembly,
wherein the center structure is disposed between the first case and the second case so as to surround one or more side surfaces of the electrode assembly and comprises a plurality of coupling portions formed at one or more edges of the center structure.

15. The method as claimed in claim 14, wherein the plurality of coupling portions comprise a plurality of fastening portions positioned at one or more edges of the center structure and a plurality of fixing members coupled to the plurality of fastening portions, and
wherein the method further comprises coupling the plurality of fastening portions of the center structure to a support substrate of an electronic device by using the plurality of fixing members.

16. The method as claimed in claim 14, wherein the first surface of the center structure comprises a first groove to which the first case is coupled, and the second surface of the center structure comprises a second groove to which the second case is coupled,
wherein coupling the first surface and the first case comprises inserting the first case into the first groove to fixedly couple the first surface and the first case, and
wherein coupling the second surface and the second case comprises inserting the second case into the second groove to fixedly couple the second surface and the second case.

17. The method as claimed in claim 16, wherein coupling the first surface and the first case further comprises applying an adhesive material to the first groove, and
wherein coupling the second surface and the second case further comprises applying an adhesive material to the second groove.

18. An electronic device comprising:
an operation unit configured to perform a preset operation;
a housing that accommodates the operation unit such that the operation unit is fixed therein; and
a secondary battery fixed to a support substrate inside the housing and configured to supply power to the operation unit,
wherein the secondary battery comprises:
an electrode assembly in which a first electrode, a separator, and a second electrode are stacked;
a first case that accommodates a first portion of the electrode assembly;
a second case that accommodates a second portion of the electrode assembly; and
a center structure disposed between the first case and the second case and surrounding one or more side surfaces of the electrode assembly, the center structure being coupled to each of the first case and the second case,
wherein the center structure comprises a plurality of coupling portions formed at one or more edges of the center structure and fastened to the support substrate.

19. The electronic device as claimed in claim 18, wherein the center structure comprises a rectangular-frame shape surrounding the one or more side surfaces of the electrode assembly, and the plurality of coupling portions comprise a plurality of fastening portions positioned at the one or more edges of the rectangular-frame shape and a plurality of fixing members coupled to the plurality of fastening portions.

20. The electronic device as claimed in claim 19, wherein the plurality of fastening portions are detachably coupled to the support substrate by the plurality of fixing members.
